(19) United States
(12) Patent Application Publication
(10) Pub. No.: US 2013/0024232 A1
(43) Pub. Date: Jan. 24, 2013

(54) ELECTRONIC METHOD AND SYSTEM FOR CONNECTING A BUYER, A SELLER, AND THIRD PARTY COURIER TO FACILITATE THE EXCHANGE OF PHYSICAL GOODS

(71) Applicant: Logan Thomas Powell, Arlington, VA (US)

(72) Inventor: Logan Thomas Powell, Arlington, VA (US)

(21) Appl. No.: 13/551,876

(22) Filed: Jul. 18, 2012

Related U.S. Application Data
(60) Provisional application No. 61/509,383, filed on Jul. 19, 2011.

(51) Int. Cl. G06Q 30/06; G06Q 10/10

(52) U.S. Cl. 705/7.19; 705/26.62

(57) ABSTRACT

Method and system of connecting and facilitating safe and efficient electronic communications between three or more parties for the purpose of an exchange of goods and/or services between the three parties. One embodiment of the present invention uses a software script that connects buyers, sellers, and third party couriers based on how close the parties are physically located to each other. This embodiment is accomplished by having a buyer, a seller, and a courier connect to a remote location-based goods exchange server (remote server) and set up an account.

### CROSS REFERENCE TO RELATED APPLICATIONS

This non-provisional application claims priority from U.S. Provisional Patent Application Ser. No. 61/509,383, entitled ELECTRONIC METHOD AND SYSTEM FOR CONNECTING A BUYER, A SELLER, AND THIRD PARTY COURIER TO FACILITATE THE EXCHANGE OF PHYSICAL GOODS filed on Jul. 19, 2011, which is incorporated herein by reference.

### FIELD OF THE INVENTION

This invention relates generally to a system and an electronic method of facilitating the exchange of physical goods and services between buyers, sellers and third party couriers.

### BACKGROUND OF THE INVENTION

The present invention is an electronic method and system for connecting buyers, sellers, and third party couriers based on location. The present invention is applicable in fields where it is desirable for an individual to buy goods locally without having to travel to the seller's physical location to obtain the goods. The present invention is also applicable in fields where it is desirable for an individual to sell goods locally without having to travel to the buyer's location or use traditional couriers such as UPS or Fed-Ex. The present invention is also applicable in fields where small local third-party couriers can connect with local buyers and sellers to provide their delivery services.

Other fields that are applicable for the present invention are areas in which the coordination of three or more parties are needed, such as: delivery service for items sold on online classifieds sites, delivery service for local businesses, car-pooling services, taxi and shuttle services, events coordination and planning services, online dating services, online/social games, community supported agriculture (CSA) or local-food infrastructures.

Currently, non-commercial buyers and sellers who wish to exchange physical goods with one another locally have to either set up a time to have the buyer pick-up the physical goods from the seller's location or have the seller transfer the goods to the buyer's physical location. The only other alternative for a buyer or seller is to contact a delivery or courier service, such as UPS or Fed-Ex, and schedule appointments that accommodate all parties (buyer, seller and courier) personally.

The method and system outlined in this application allows local buyers and sellers to coordinate transactions and delivery logistics with three independent parties in one integrated solution. This method and system also allows individuals to provide delivery services without the need for a support staff. This method and system facilitates the interaction between these three parties in a secure and convenient fashion through a software script that considers the constraints of all parties and provides a simple way for all three parties to coordinate their tasks to complete the transaction.

### SUMMARY OF THE INVENTION

The present invention, in one embodiment of the presently described invention, uses a software script that connects buyers, sellers, and third party couriers based on how close the parties are physically located to each other. This embodiment is accomplished by having a buyer, a seller, and a courier connect to a remote location-based goods exchange server (remote server) and set up an account.

The present invention, in one embodiment, has a seller and a courier setting up an account by adding profile information and his/her schedule of available delivery or pick-up times. The present invention, in another embodiment, has a buyer set up an account by adding his/her profile information. The present invention, in yet another embodiment, has a local seller posting a description and/or photographs of an item he/she wishes to sell onto the remote server.

The present invention, in one embodiment, has a buyer visiting the remote server to search for and ultimately buy the seller's item. The present invention, in another embodiment, has a potential buyer electronically communicating with the seller about the seller's posted item. The present invention, in yet another embodiment, has a buyer selecting the seller's item to purchase and paying both the seller and courier through electronic means.

The present invention, in one embodiment, has the buyer selecting a courier to deliver the seller's item. The present invention, in another embodiment, has a software script compile a list of available couriers and delivery times using: the seller's schedule of available pick-up times, the courier's schedule of available delivery times, and deliverability factors, such as the size/weight of the item and the dimensions of the courier's vehicle. This list is sent to the buyer, who chooses his/her desired delivery courier and time.

The present invention, in one embodiment, has the software script analyze a number of factors to calculate a shipping price that the buyer will be responsible for paying. Examples of factors used to calculate a delivery price include, but are not limited to, the number of stairs involved in the delivery and whether the buyer/seller will help with courier pick-up or drop-off the item.

The present invention, in another embodiment, has a software script analyze a number of factors to calculate a delivery route with the shortest travel time for the courier. Examples of factors used to calculate the route include, but are not limited to: 1) the distance between the pick-up and drop-off locations, 2) the location of the courier at the time the calculation is made, 3) the estimated time it will take to travel from the courier's current location to the pick-up location.

The present invention, in one embodiment, notifies all parties of the upcoming delivery via electronic communications. The present invention, in another embodiment, uses electronic means to confirm pick-up and delivery of the item. The present invention, in yet another embodiment, uses electronic communications between the courier and the remote server to track the physical location of the courier throughout the day in order to assigns new deliveries to that courier for that day. The present invention, in yet another embodiment, uses the electronic confirmation to automatically trigger the release of monies from buyer's escrow to both the seller and courier, which then triggers the removal of the seller's item posting from a searchable index.

The present invention, in one embodiment, allows buyers and sellers to rate the other parties involved in the physical goods exchange. The present invention, in another embodiment, allows the ratings to be viewed by all buyers, sellers, and local third party couriers with website accounts. The present invention, in another embodiment, allows a seller to post item information, created on the external server, into a posting on a third party website as well as permit a buyer to initiate delivery of the seller's item through the resulting post in the third party website by using a web widget user interface.

### BRIEF DESCRIPTION OF THE DRAWINGS

FIG. 1 is a process flow for electronically connecting a buyer, a seller, and a courier to facilitate the sale and delivery of goods;

FIG. 2 is a process flow for having a courier add profile information and available delivery times;

FIG. 3 is a schematic of the user interface;

FIG. 4 is a schematic of the courier's profile and availability;

FIG. 5 is a process flow for having a seller post an item on the remote server;

FIG. 6 is a schematic of the seller/buyer's profile;

FIG. 7 is a schematic of the seller/buyer's chosen location;

FIG. 8 is a schematic of the buyer/seller's activation of electronic alerts;

FIG. 9 is a schematic of the seller's item information;

FIG. 10 is a schematic of the item's defect(s) and delivery widget code button;

FIG. 11 is a schematic of the seller's remote server activity;

FIG. 12 is a process flow for the buyer's item search;

FIG. 13 is a schematic of the buyer's find-item webpage;

FIG. 14 is a schematic of the buyer's list-form search results;

FIG. 15 is a schematic of the buyer's map-form search results;

FIG. 16 is a schematic of the selected item's detailed information;

FIG. 17 is a schematic of pre-confirmation correspondence;

FIG. 18 is a process flow for generating a schedule of available couriers and delivery times for the buyer;

FIG. 19 is a schematic of the seller's available delivery times;

FIG. 20 is a schematic of the buyer's delivery questions;

FIG. 21 is a schematic of the list of available couriers, delivery times, and delivery prices;

FIG. 22 is a process flow for purchase conformation and release of monies from escrow;

FIG. 23 is a schematic of purchase conformation;

FIG. 24 is a process flow for notifying and confirming delivery of the purchased item;

FIG. 25 is a schematic of the seller rating system;

FIG. 26 is an example of how delivery schedules are created for one courier in the course of one day;

FIG. 27 is a network diagram of electronic communications between the buyer, seller, and courier;

FIG. 28 is a schematic of the buyer's confirmation number;

FIG. 29 is a process flow for having a seller use a web widget to post item information and for allowing a buyer to initiate the delivery of the seller's item on a third party website through the external server; and

FIG. 30 is a schematic of the seller's item posting on the third party website.

### DETAILED DESCRIPTION OF THE INVENTION

The invention will now be described in detail in relation to a preferred embodiment and implementation thereof, which is exemplary in nature and descriptively specific as disclosed. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

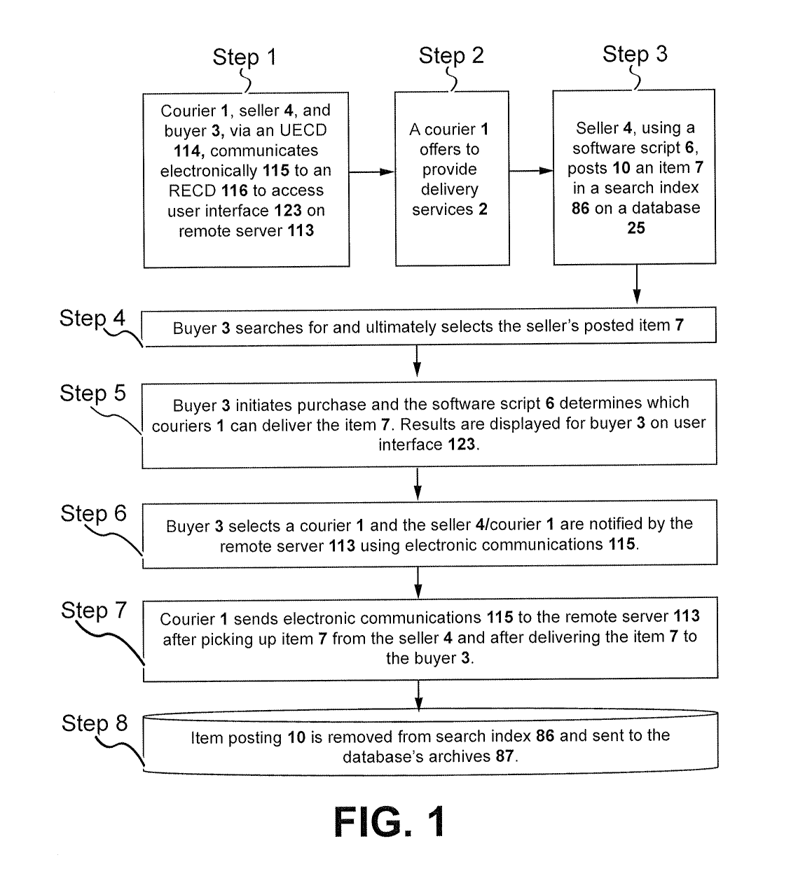

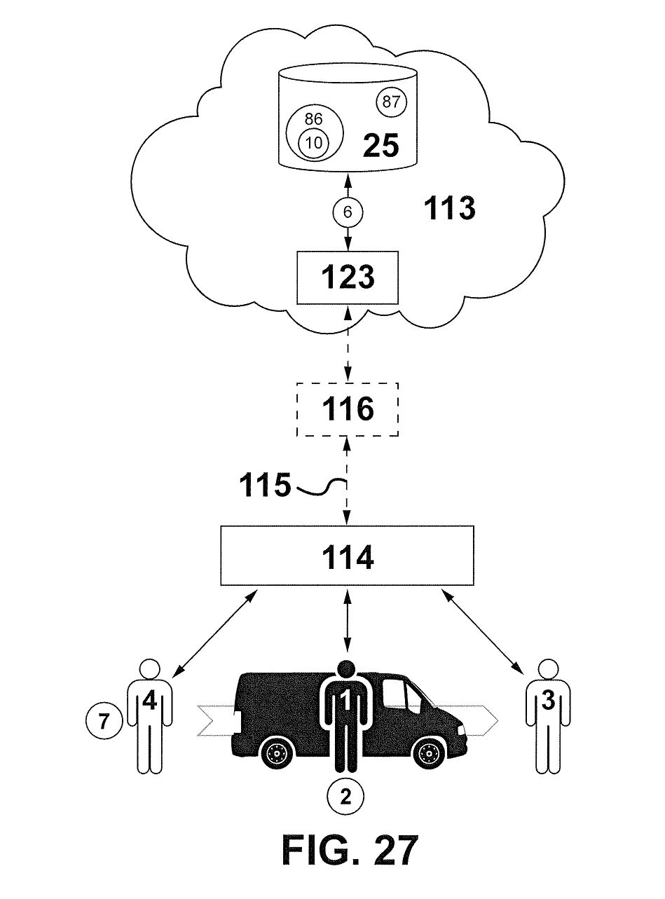

Referring now to FIG. 1, one embodiment of the presently disclosed invention shows the process overview for electronically connecting a buyer, a seller, and courier to facilitate the sale and delivery of goods. FIG. 27 shows the accompanying schematic to the process flow described in FIG. 1. More specifically, FIG. 27 is a network diagram of the electronic communications between the buyer, seller, and courier.

Referring now to FIG. 1, one embodiment of the presently disclosed invention, starting at Step 1, has a courier 1, a seller 4, and a buyer 3 go to a user interface 123 by connecting to a remote server 113 (See FIG. 27). In Step 1 of FIG. 1, connections to the remote server 113 are achieved using a user electronic communication device (UECD) 114 to communicate electronically 115 with a remote server electronic communication device 116 (RECD) (See FIG. 27).

Examples of user interfaces include, but are not limited to, a homepage (Not Shown) on a website (Not Shown) and a home screen (Not Shown) on a mobile device (Not Shown). Examples of UECDs 114 (See FIG. 27) include, but are not limited to, a computer (Not Shown), an electronic tablet (Not Shown) and a cell-phone (Not Shown). Examples of electronic communications 115 (See FIG. 27) include, but are not limited to, text messages (Not Shown), email messages (Not Shown), and Internet communications (Not Shown). Examples of RECDs 116 (See FIG. 27) that connect to the remote server 113 (See FIG. 27) include, but are not limited to, 1) a web browser (Not Shown), 2) a VOIP/voice Gateway (Not Shown), and 3) an SMS/text message gateway (Not Shown).

Starting at Step 2 of FIG. 1, the courier 1 offers delivery services 2 (See FIG. 27). Starting at Step 3 of FIG. 1, the seller 4, wishing to sell an item 7, uses a software script 6 to create an item posting 10. (See FIG. 27). In Step 3 of FIG. 1, the item posting 10 is located on a search index 86 within in a database 25 (See FIG. 27). The database 25 and software script 6 are both located within the remote server 113 (See FIG. 27).

Starting at Step 4 of FIG. 1, the buyer 3, searches for and ultimately selects the seller's posted item 7. If the buyer 3 initiates purchase (Not Shown) of the seller's item 7, then, starting at Step 5 of FIG. 1, the software script 6 determines which couriers 1 can deliver the item 7 to the buyer 3 (See FIG. 27). In Step 5 of FIG. 1, the software script 6 displays its results (Not Shown) to the buyer 3 on the remote server 113 (See FIG. 27). Next, starting at Step 6 of FIG. 1, the buyer 3 selects his/her desired courier 1 and both the seller 4 and the chosen courier 1 are notified by the remote server 113 using electronic communications 115 (See FIG. 27).

Starting at Step 7 of FIG. 1, the courier 1 picks up the item 7 from the seller 4 and delivers the item 7 to the buyer 3. In Step 7 of FIG. 1, the courier 1, after each successful pick-up (Not Shown) and drop-off (Not Shown), uses electronic communications 115 to notify the remote server 113 (See FIG. 27). Lastly, starting at Step 8 of FIG. 1, the seller's item posting 10 is removed from the search index 86 and sent to the database's archives 87 (See FIG. 27).

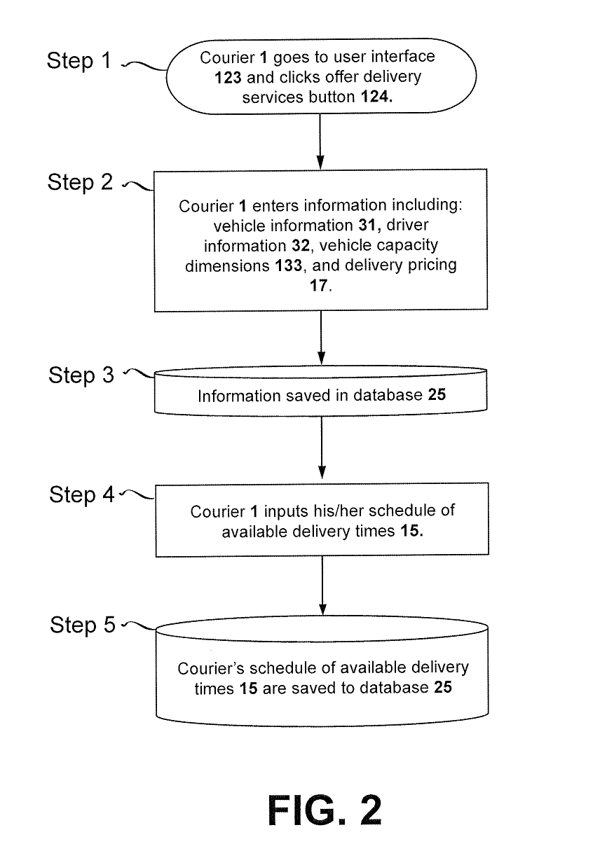

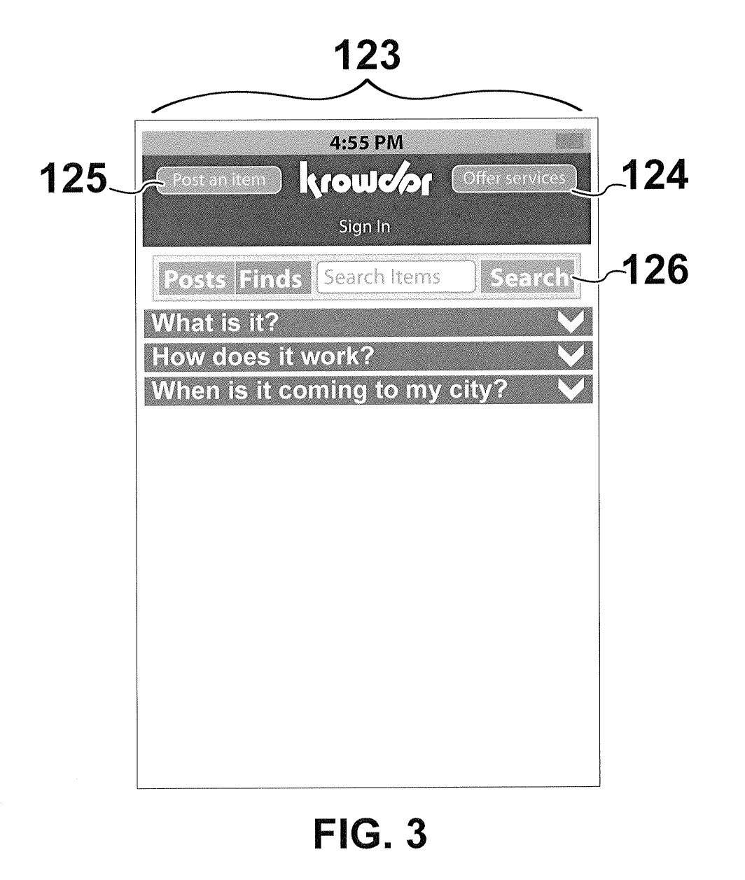

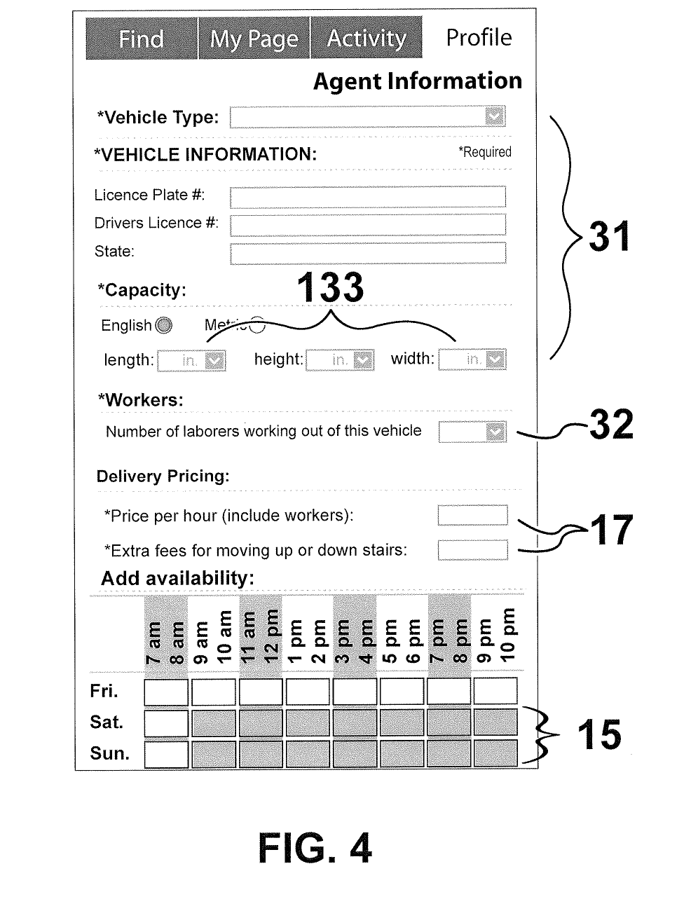

Referring now to FIG. 2, one embodiment of the presently disclosed invention shows a process flow for having a courier add available delivery times to the remote server. FIGS. 3 and 4 show the accompanying schematics to the process flow described in FIG. 3. More specifically, FIG. 3 is a schematic of the user interface and FIG. 4 is a schematic of the courier profile information and availability.

Referring now to FIG. 2, one embodiment of the present invention, starting at Step 1, has a courier 1 going to the user interface 123 and clicking the offering-delivery-services button 124 (See FIG. 3). In Step 2 of FIG. 2, the courier 1 then adds information (Not Shown), such as: vehicle information 31, available driver(s) information 32, vehicle capacity dimensions 133, and delivery pricing 17 (See FIG. 4). Starting at Step 3 of FIG. 2, all imputed information (Not Shown) is then saved on the database 25 (See FIG. 27). Next, in Step 4 of FIG. 2, the courier 1 adds his/her schedule of available delivery times 15 (See FIG. 4). Lastly, starting at Step 5 of FIG. 2, the schedule of available delivery times 15 (See FIG. 4) is saved on the database 25 (See FIG. 27).

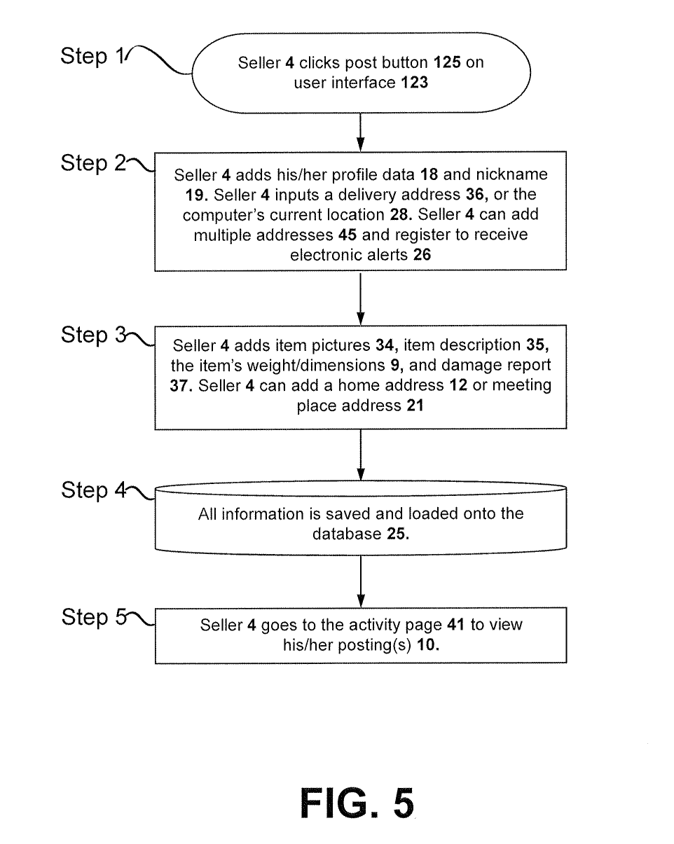

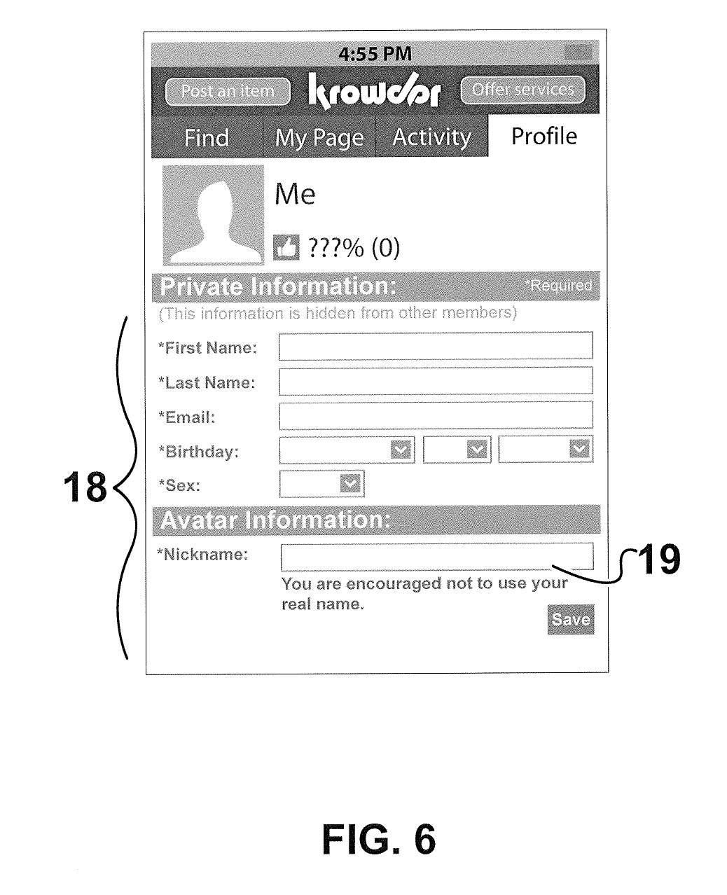

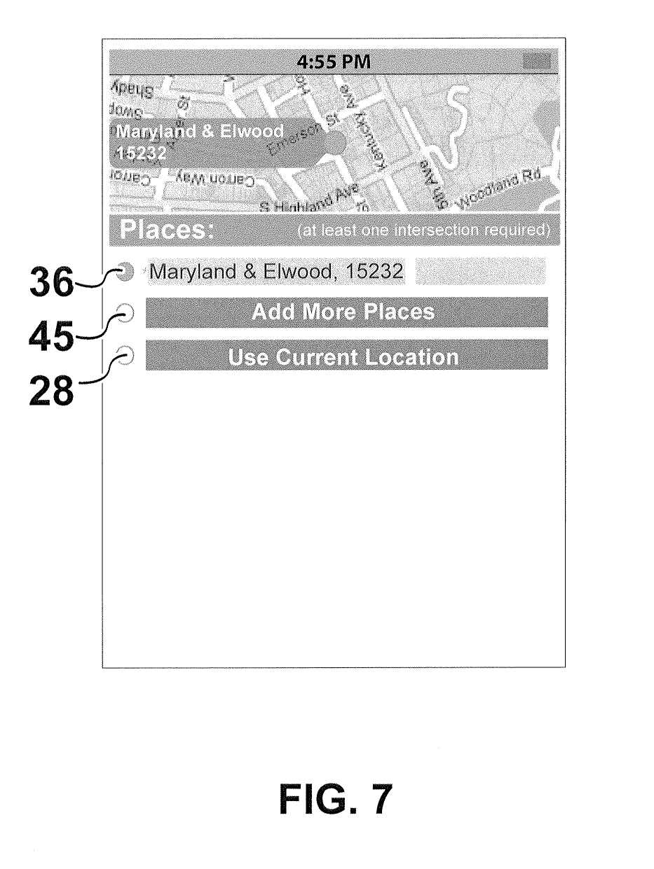

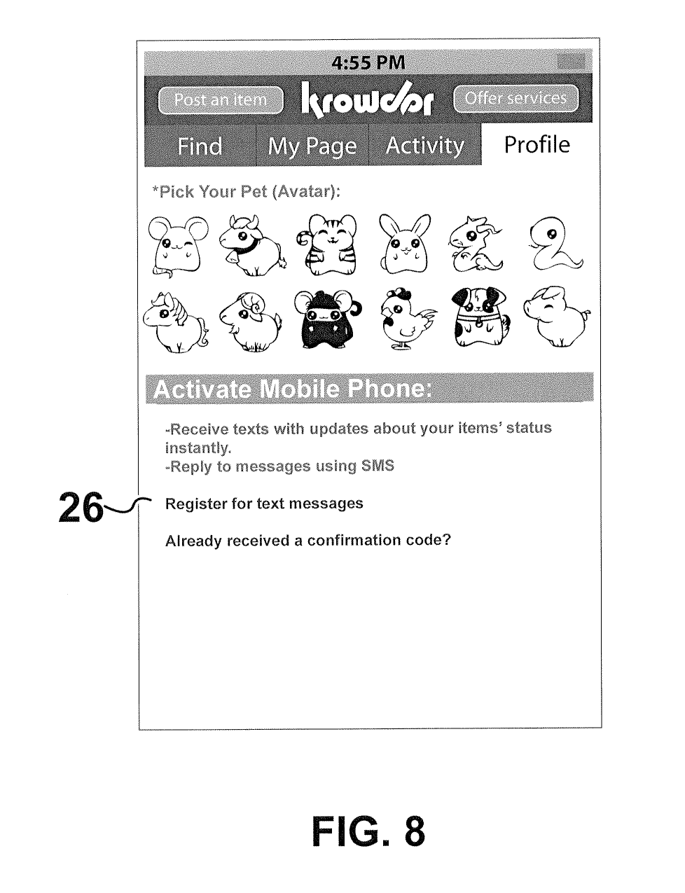

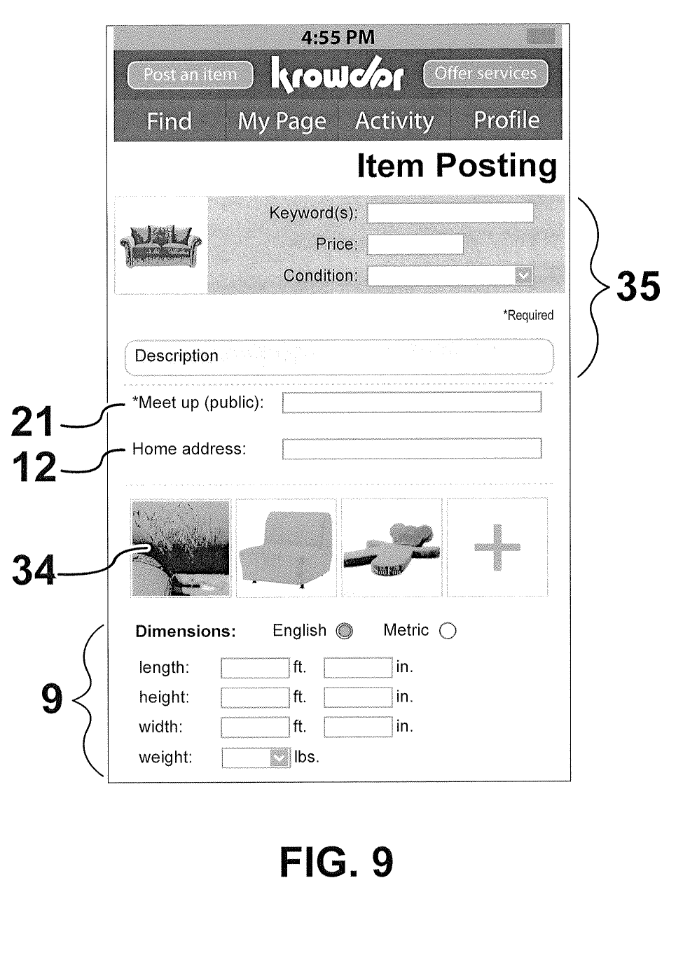

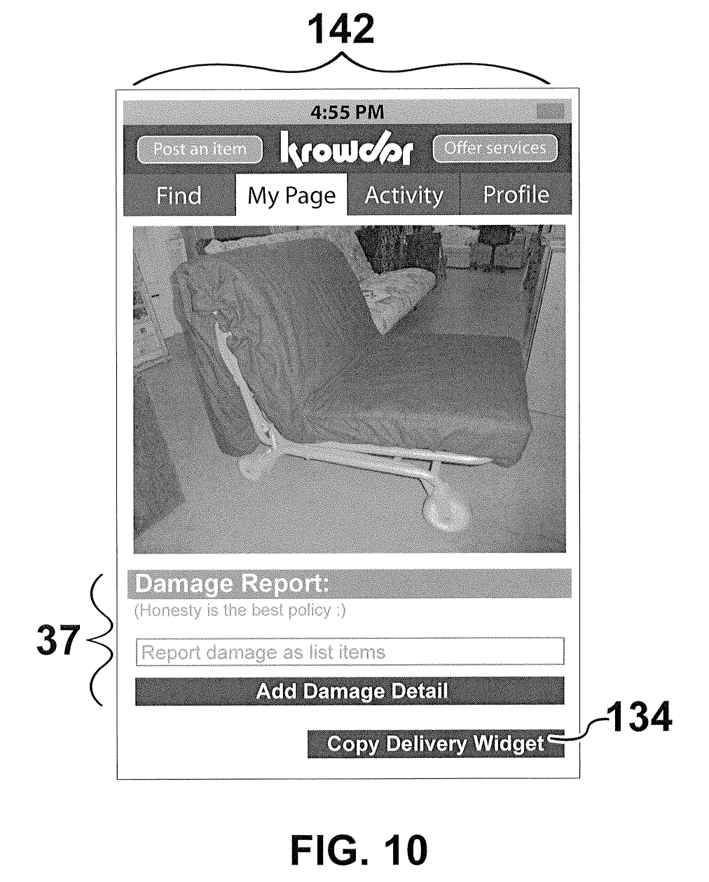

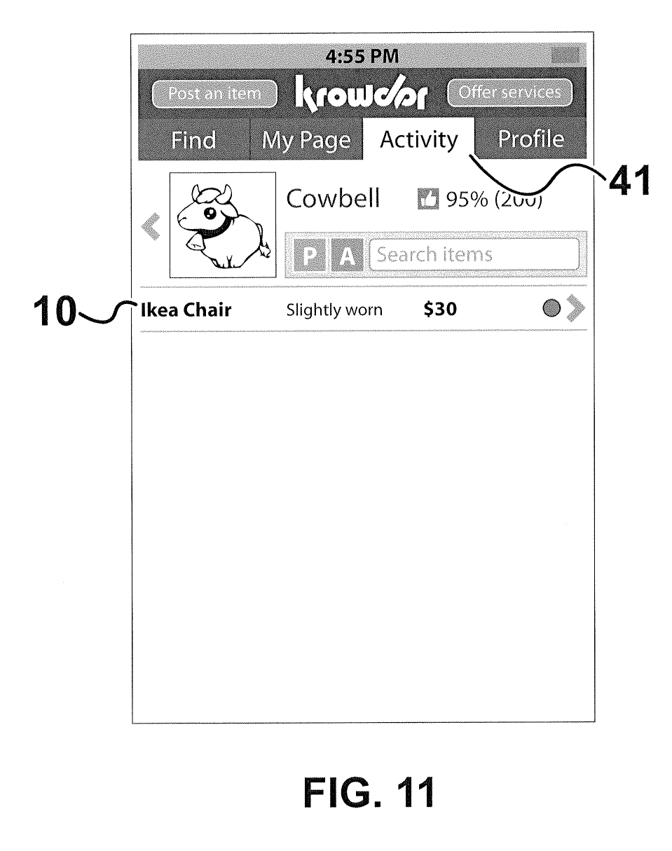

Referring now to FIG. 5, one embodiment of the presently disclosed invention shows a process flow for having a seller post an item for sale on the remote server. FIG. 3 and FIGS. 6 through 11 show the accompanying schematics to the process flow described in FIG. 5. More specifically, FIG. 3 is a schematic of the user interface; FIG. 6 is schematic of the seller/buyer's profile page; FIG. 7 is a schematic of the seller/buyer's chosen location; FIG. 8 is a schematic of buyer/seller's activation of electronic alerts; FIG. 9 is a schematic of the seller's item information; FIG. 10 is a schematic of the item's defect(s); and FIG. 11 is a schematic of the seller's remote server activity.

Referring now to FIG. 5, one embodiment of the presently disclosed invention, starting at Step 1, has a seller 4 initiating an item sale (Not Shown) by clicking the post button 125 (See FIG. 3) on the user interface 123 (See FIG. 3). Starting at Step 2 of FIG. 5, the seller 4 enters his/her profile data 18 (See FIG. 6), a chosen nickname 19 (See FIG. 6), and a delivery address 36 (See FIG. 7). In Step 2 of FIG. 5, the seller 4 can also use the current user's location 28 as his/her delivery address 36 (See FIG. 7). Also, in Step 2 of FIG. 5, the seller 4 can add multiple addresses 45 (See FIG. 7) and can opt to receive electronic alerts 26 (See FIG. 8) by electronic communications 115 (See FIG. 27).

Starting at Step 3 of FIG. 5, the seller 4 then adds an item picture 34, an item description 35, and the item's weight/dimensions 9 (See FIG. 9). In Step 3 of FIG. 5, the seller 4 may include a damage report 37, on the item-posting page 142, if pertinent (See FIG. 10). Also, in. Step 3 of FIG. 5, the seller 4 may enter his/her home address 12 or enter a potential buyer-seller meeting place address 21 (See FIG. 9). Next, starting at Step 4 of FIG. 5, all information (Not Shown) is saved on the database 25 (See FIG. 27). Lastly, starting at Step 5 of FIG. 5, the seller 4 may go to the activity page 41 to view his/her item posting(s) 10 (See FIG. 11).

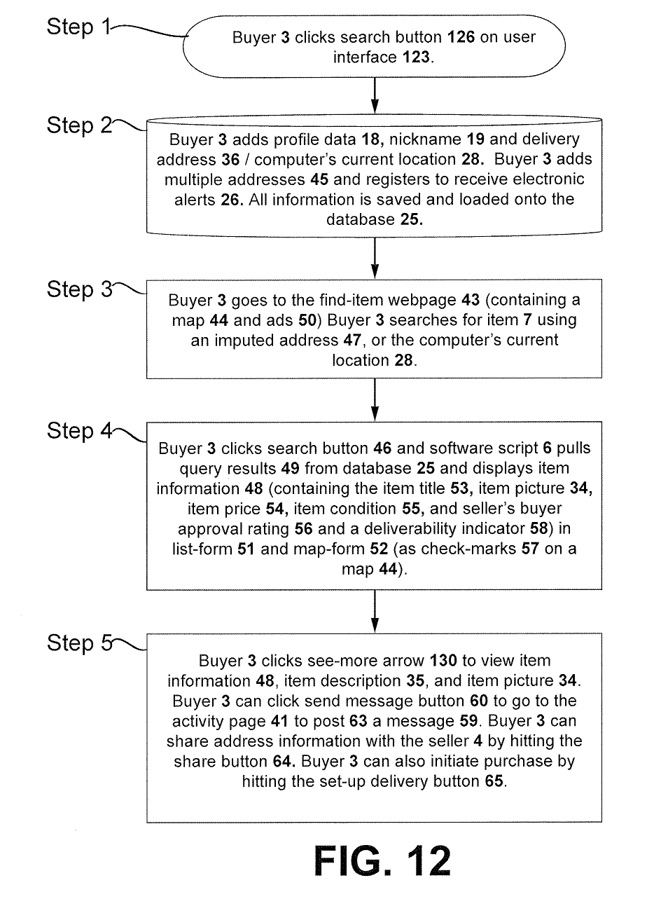

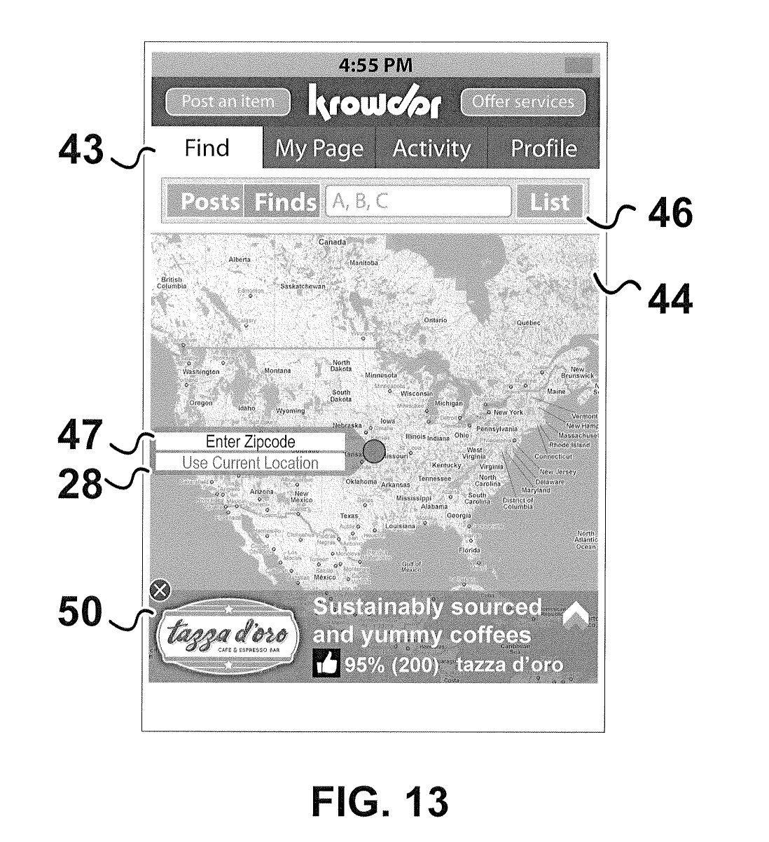

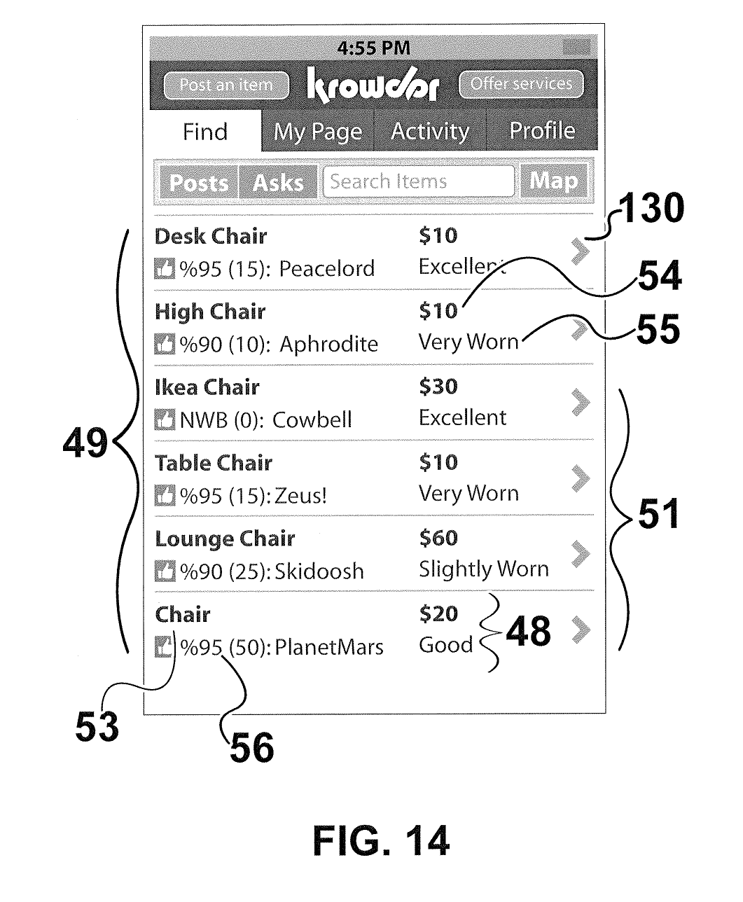

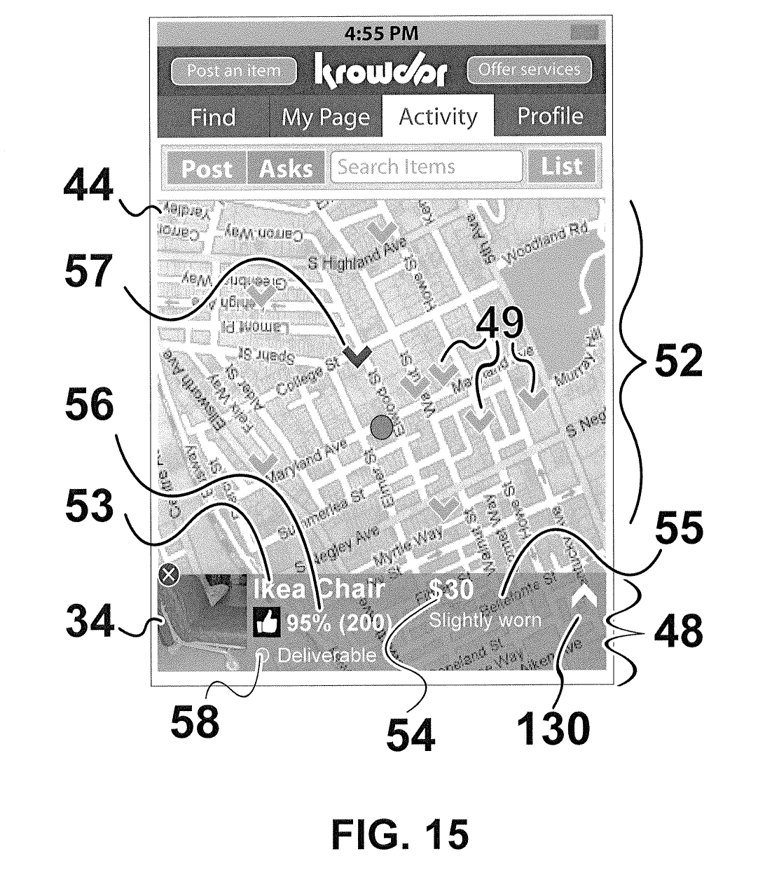

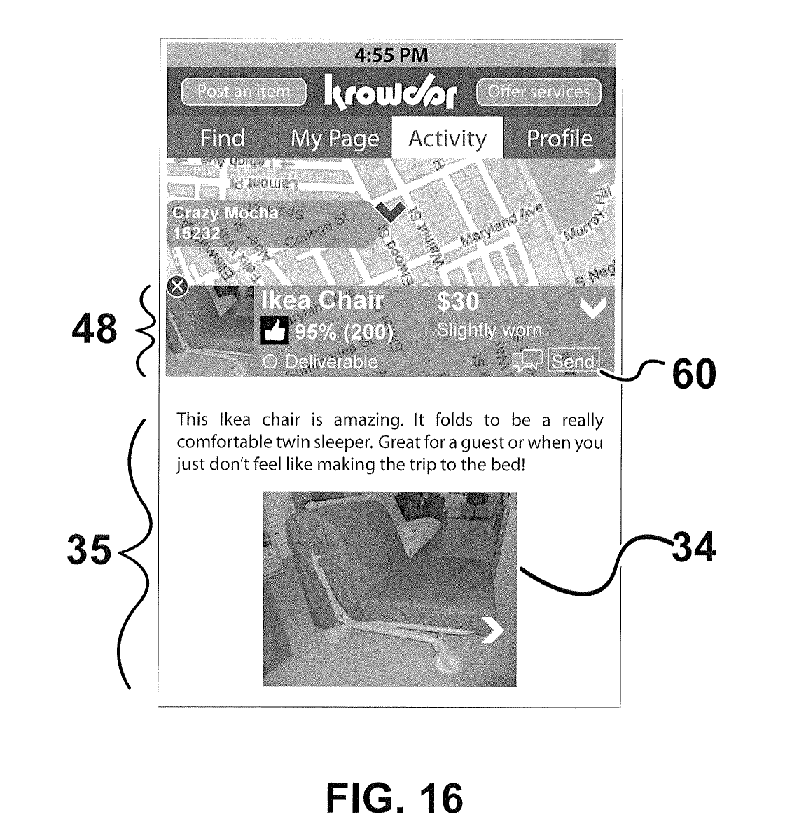

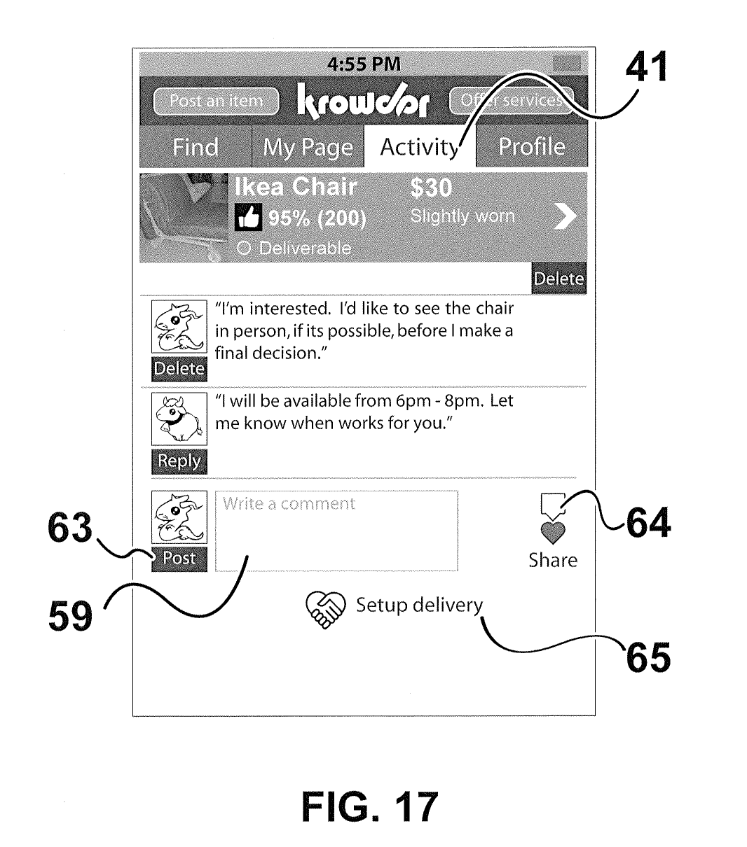

Referring now to FIG. 12, one embodiment of the presently disclosed invention shows a process flow for allowing a potential buyer to search for a seller's posted item. FIG. 3 and FIGS. 13 through 17 show the accompanying schematics to the process flow described in FIG. 12. More specifically, FIG. 3 is a schematic of the user interface; FIG. 13 is a schematic showing the buyer's find-item webpage; FIG. 14 is a schematic of the buyer's list-form search results; FIG. 15 is a schematic of the buyer's map-form search results; FIG. 16 is a schematic of the selected item's detailed information; and FIG. 17 is a schematic of buyer-seller pre-confirmation correspondence.

One embodiment of the present invention, as seen in FIG. 12, shows, starting at Step 1, has a buyer 3 initiating a search (Not Shown) by clicking the search button 126 on the user interface 123 (See FIG. 3). Then, in Step 2 of FIG. 12, the buyer 3 adds his/her profile data 18 (See FIG. 6), chosen nickname 19 (See FIG. 6), and a delivery address 36 (See FIG. 7), which can be the computer's current location 28 (See FIG. 7). In Step 2 of FIG. 12. The buyer 3 can add multiple addresses 45 (See FIG. 7) and can opt to receive electronic alerts 26 (See FIG. 8). All information (Not Shown) is saved on the database 25 (See FIG. 27).

Starting at Step 3 of FIG. 12, the buyer 3 conducts a search (Not Shown) by going to the find-item webpage 43, which contains a map 44 and possibly location-based advertisements 50 (See FIG. 13). In Step 3 of FIG. 12, the buyer 3 can search for items 7 based on an imputed address 47 or the current user's location 28 (See FIG. 13).

Starting at Step 4 of FIG. 12, the buyer 3 enters keywords (Not Shown) and hits the search button 46 (See FIG. 13). In Step 4 of FIG. 12, the software script 6 (See FIG. 27) pulls query results 49 (See FIGS. 14 & 15) from item postings 10 (See FIG. 27) stored in the database 25 (See FIG. 27). Also, in Step 4 of FIG. 12, the query results 49 (See FIGS. 14 & 15) are displayed for the buyer 3 in both list-form 51 (See FIG. 14) and map-form 52 (See FIG. 15). Additionally in Step 4 of FIG. 12, query results 49 displayed in map-form 52 are seen as check marks 57 on a map 44, which reveal item information 48 when clicked (See FIG. 15).

Moreover, in Step 4 of FIG. 12, item information 48 (See FIGS. 14 & 15), in both list-form 51 (See FIG. 14) and map-form 52 (See FIG. 15) may include: an item title 53 (See FIGS. 14 & 15), the item picture 34 (See FIG. 15), an item price 54 (See FIGS. 14 & 15), a description of the item's condition 55 (See FIGS. 14 & 15), the seller's buyer approval rating 56 (See FIGS. 14 & 15) and a deliverability indicator 58 (See FIG. 15), which states whether the item 7 can be delivered to the buyer 3. The deliverability indicator 58 (See FIG. 15) is calculated using a number of factors (Not Shown). Examples of factors (Not Shown) used to calculate deliverability include, but are not limited to the courier's vehicle capacity 133 (See FIG. 4) and the distances between the courier, seller, and buyer's locations (Not Shown).

If the buyer 3 wishes to see all item information 48 (See FIG. 16) along with the full item description 35 (See FIG. 16), and full item picture 34 (See FIG. 16), the buyer 3, starting at Step 5 of FIG. 12, can click on a see-more arrow 130 (See FIGS. 14 & 15). In Step 5 of FIG. 12, the buyer 3 can also communicate with the seller 4 by clicking the send message button 60 (See FIG. 16). Clicking the send message button 60 (See FIG. 16) sends the buyer 3 to the activity page 41 (See FIG. 17), where the buyer 3 can create and post 63 (See FIG. 17) a message 59 (See FIG. 17). Also in Step 5 of FIG. 12, another embodiment of the presently described invention allows the buyer 3 to share his/her delivery address 36 (See FIG. 7) with the seller 4 by hitting the share button 64. In Step 5 of FIG. 12, the buyer 3 can also initiate purchase (Not Shown) of an item 7 by hitting the set-up delivery button 65 (See FIG. 17).

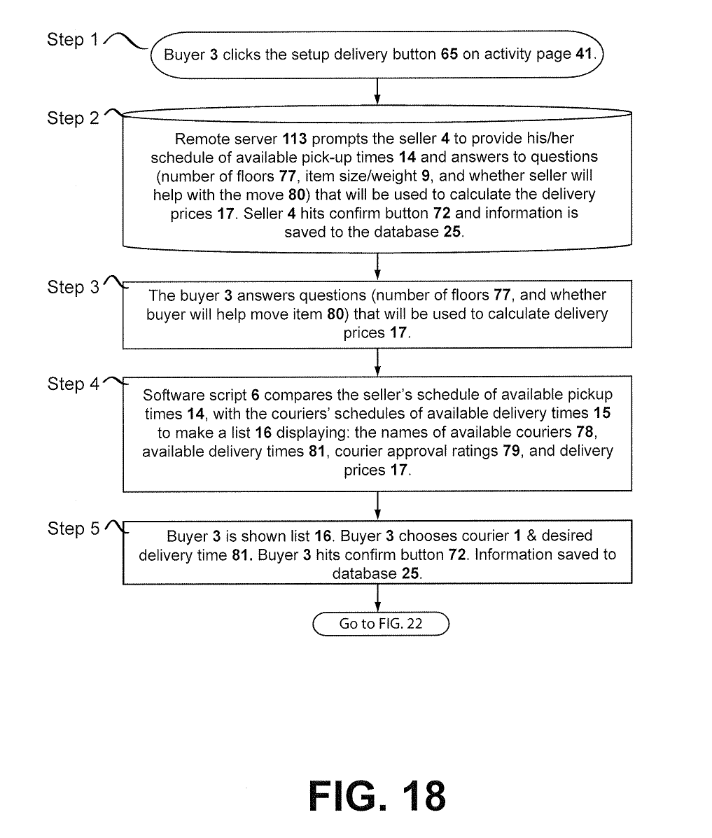

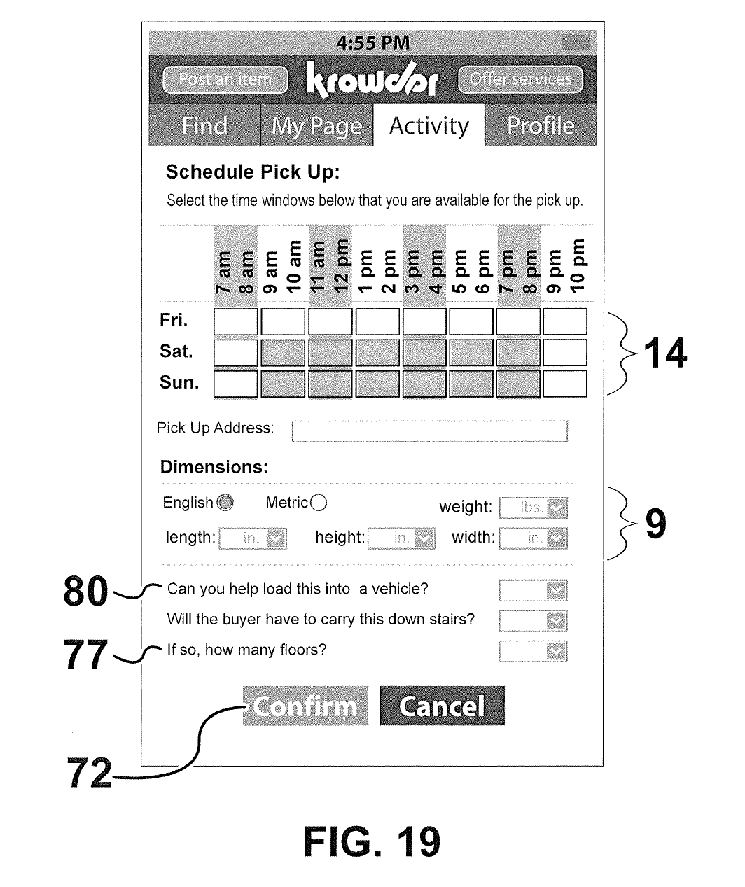

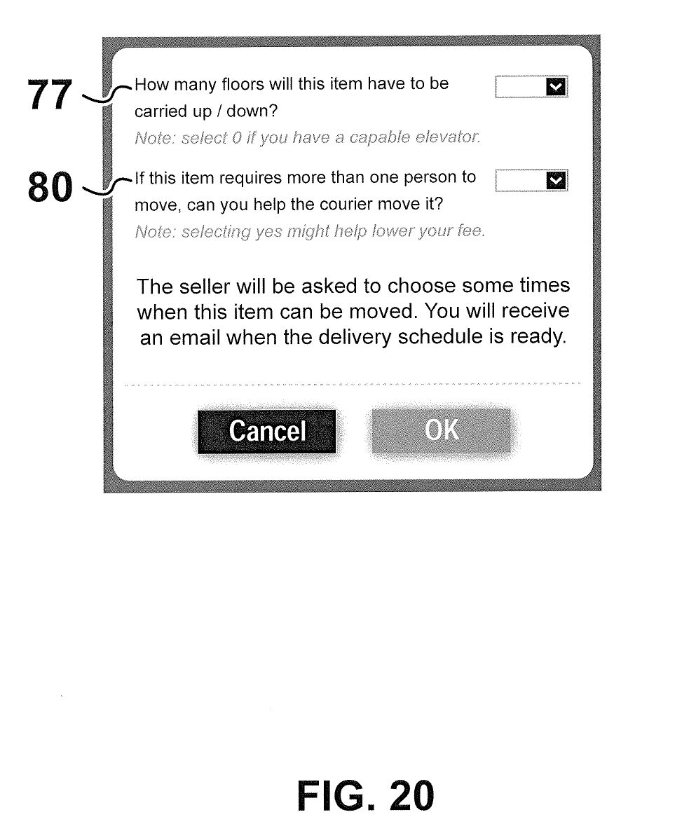

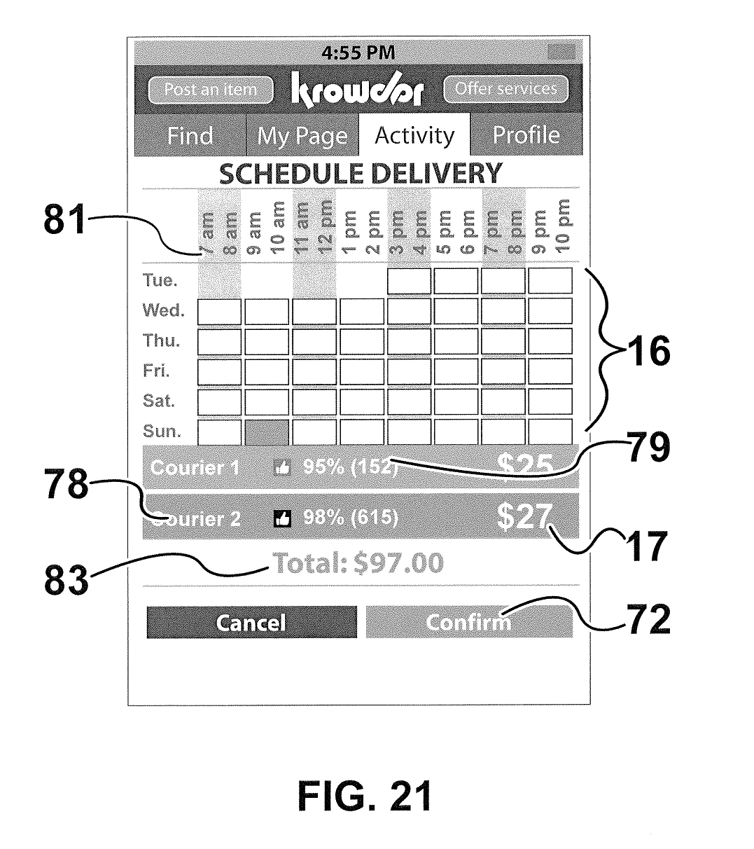

Referring now to FIG. 18, one embodiment of the presently disclosed invention further shows a process flow for generating a schedule of available couriers and delivery times for the buyer. FIGS. 20 through 21 show the accompanying schematics to the process flow as described in FIG. 18. More specifically, FIG. 19 is a schematic of the seller's available delivery times; FIG. 20 is a schematic of the buyer's delivery questions; and FIG. 21 is a schematic of the list of available couriers, delivery times, and delivery prices.

Referring now to FIG. 18, the buyer 3, starting at Step 1, clicks the setup delivery button 65 on the activity page 41 (See FIG. 17). Starting at Step 2 of FIG. 18, the remote server 113 (See FIG. 27) prompts the seller 4 to provide his/her schedule of available pick-up times 14 (See FIG. 19). During Step 2 of FIG. 18, the seller 4 will also be asked a number of questions (Not Shown), including but not limited to: the number of floors involved in the delivery 77, the item's size and weight 9, and whether the seller will help move the item 80 (See FIG. 19). The seller's answers will be used to calculate delivery prices 17 (See FIG. 21). In Step 2 of FIG. 18, the seller 4 hits the confirm button 72 (See FIG. 19) and all information (Not Shown) is saved on the database 25 (See FIG. 27). Starting at Step 3 of FIG. 18, the buyer 3 is also asked a number of questions that will be used to calculate delivery prices 17 (See FIG. 21), which include, but is not limited to: the number of floors involved in the delivery 77 (See FIG. 20) and whether the buyer will help move the item 80 (See FIG. 20).

Starting at Step 4 of FIG. 18, the software script 6 (See FIG. 27) then compares the seller's schedule of available pickup times 14 (See FIG. 19), with the couriers' schedules of available delivery times 15 (See FIG. 4) to make a list 16 (See FIG. 21). The list 16 may include: the names of the available couriers 78, delivery prices 17, courier approval ratings 79, and delivery times 81 (See FIG. 21). Lastly, starting at Step 5 of FIG. 18, the buyer 3 is shown the list 16 and, after selecting his/her desired courier 1 and desired delivery times 81, hits the confirm button 72 (See FIG. 21). In Step 5 of FIG. 18, all information (Not Shown) is saved on the database 25. (See FIG. 27).

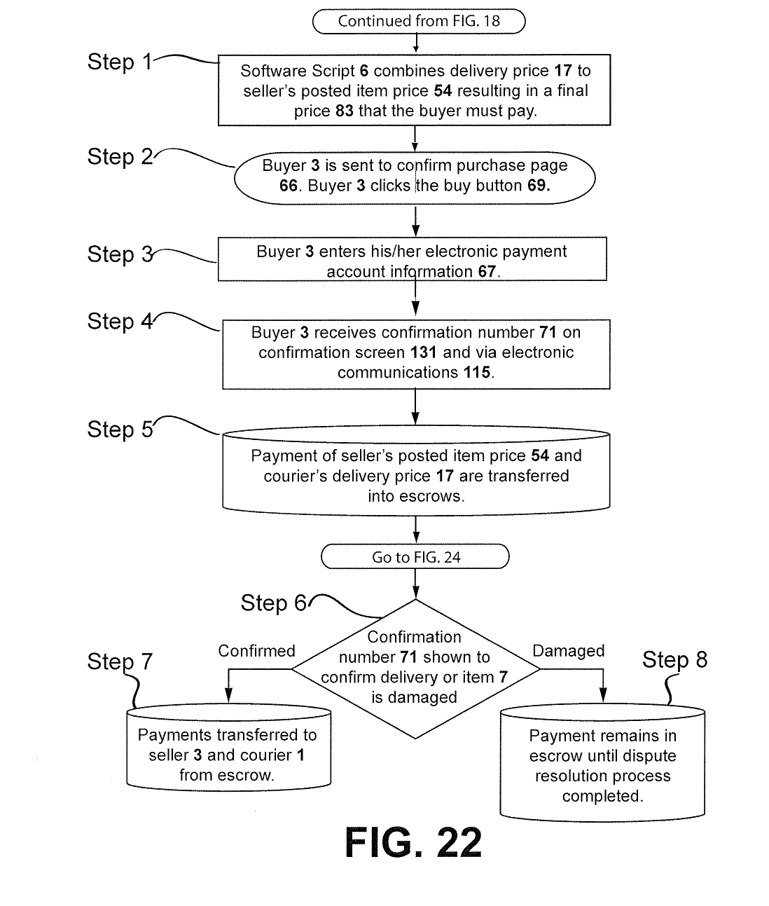

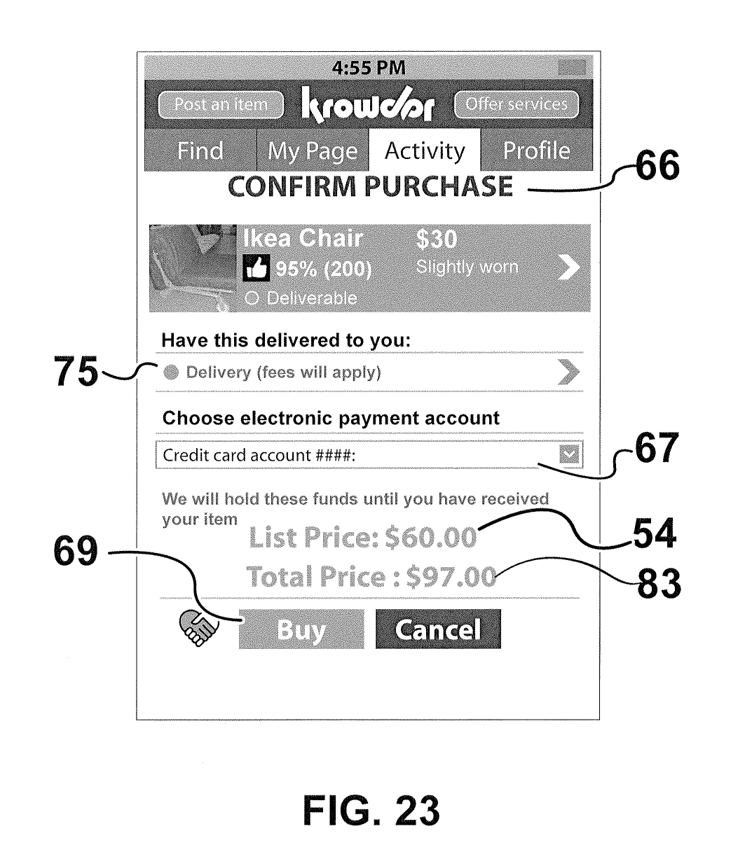

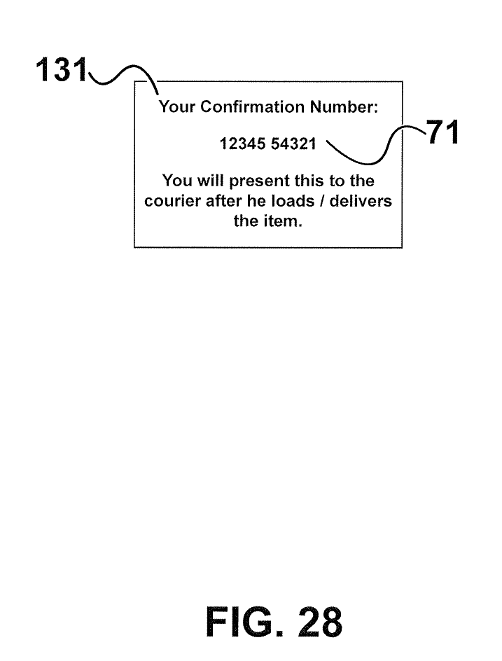

Referring now to FIG. 22, one embodiment of the presently disclosed invention shows a process flow for confirming purchase of a seller's posted item and releasing monies from escrow. FIGS. 23 and 28 show the accompanying schematics of the buyer's confirmation. More specifically, FIG. 23 shows a schematic of the buyer's purchase confirmation and FIG. 28 shows a schematic of the buyer's confirmation number.

Starting at Step 1 of FIG. 22, one embodiment of the present invention shows, after the buyer 3 selects his/her chosen courier 1 and hits the confirm button 72 (See FIG. 21), the software script 6 combining the delivery price 17 (See FIG. 21) to the seller's posted item price 54 (See FIG. 23), resulting in a final price 83 (See FIG. 23) that the buyer 3 is responsible for paying. Next, starting at Step 2 of FIG. 22, the buyer 3 is sent to a confirm-purchase-webpage 66 (See FIG. 23). Starting at Step 3 of FIG. 22, the buyer 3 enters his/her electronic payment account information 67, and clicks the buy button 69 (See FIG. 23) Examples of electronic payment accounts (Not Shown) include, but are not limited to: a bank account (Not Shown), credit card (Not Shown), or other electronic money accounts (Not Shown).

Starting at Step 4 of FIG. 22, the buyer 3 receives a confirmation number 71 that appears on a payment confirmation screen 131 (See FIG. 28). In Step 4 of FIG. 22, the buyer 3 will also receive the confirmation number 71 (See FIG. 28) through electronic communications 115 (See FIG. 27). Starting at Step 5 of FIG. 22, payment (Not Shown) of the seller's posted item price 54 (See FIG. 23) and the courier's delivery price 17 (Refer to FIG. 21) are sent to separate escrow accounts (Not Shown).

After the courier 1 goes to the buyer 3 to deliver the item 7, starting at Step 6 of FIG. 22, the buyer 3 gives the courier 1 the buyer's confirmation number 71 (See FIG. 28). In Step 6 of FIG. 22, if the buyer 3 receives the item 7 undamaged, then starting at Step 7 of FIG. 22, the payment (Not Shown) will be transferred from escrow (Not Shown) to the seller 4 and courier 1. In Step 6 of FIG. 22, if the buyer 3 does not receive the item 7 or the item 7 is received damaged (Not Shown) then, starting at Step 8 of FIG. 22, the payment (Not Shown) will remain in courier's escrow (Not Shown) until a dispute resolution process mechanism (Not Shown) is completed.

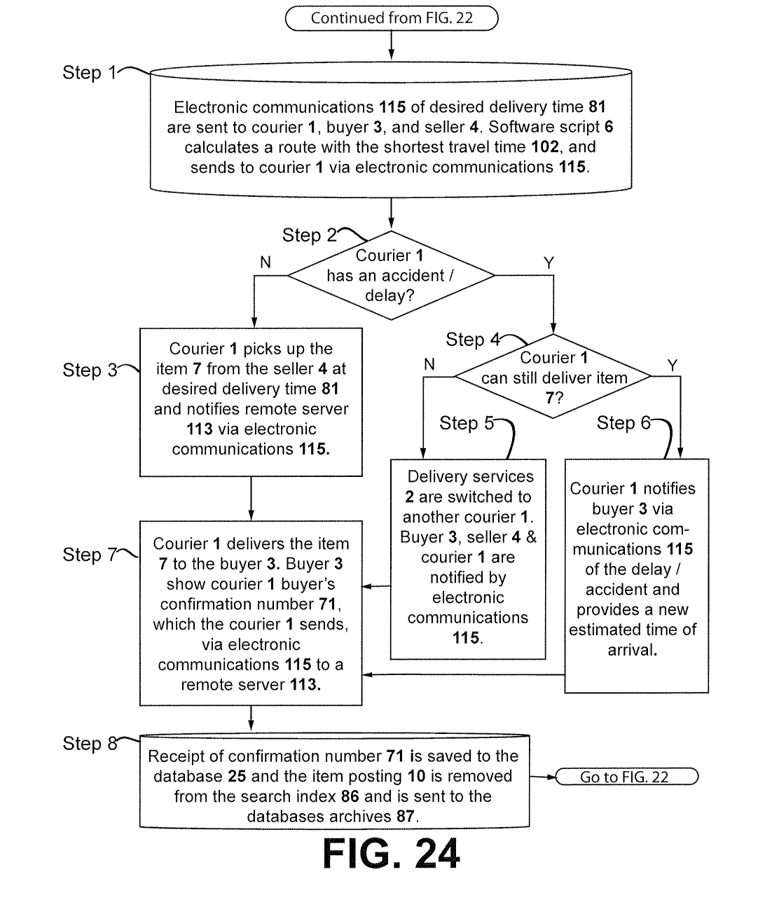

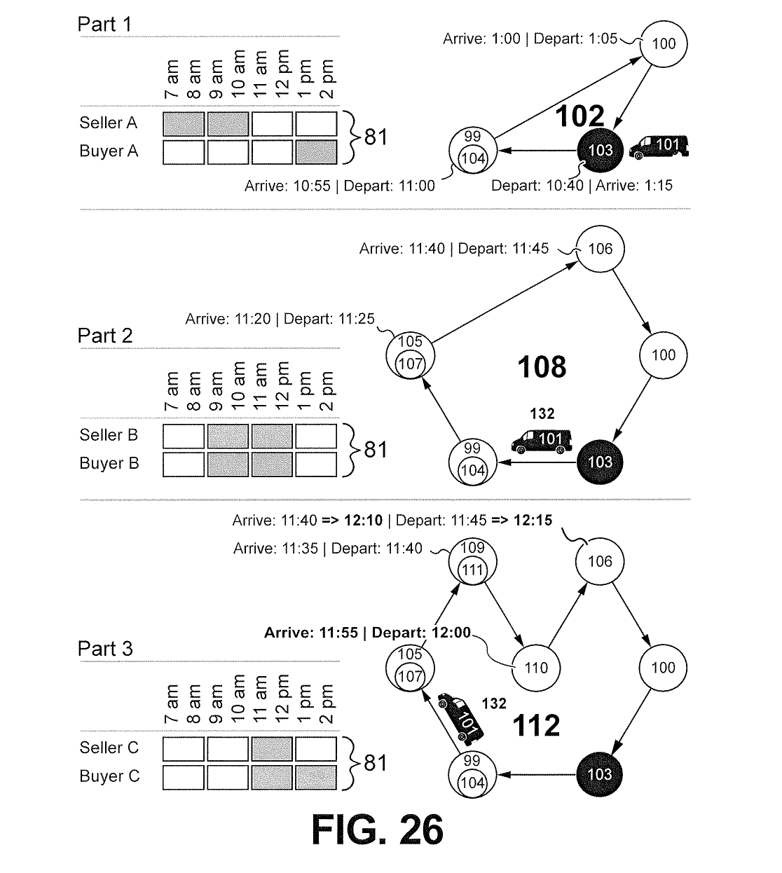

Referring now to FIG. 24, one embodiment of the presently disclosed invention shows a process flow for notifying and confirming delivery of the purchased item. Starting at Step 1 of FIG. 24, the buyer 3, the seller 4, and the chosen courier 1, are notified via electronic communications 115 (See FIG. 27) of the delivery times 81 (See FIG. 21). In Step 1 of FIG. 24, the software script 6 (See FIG. 27) calculates a route with the shortest travel time 102 (Refer to FIG. 26), which is then given to the chosen courier 1, via electronic communications 115 (See FIG. 27).

Starting at Step 2 of FIG. 24, if there are no accidents or delays (Not Shown), the courier 1, then starting at Step 3 of FIG. 24, picks up the item 7 (Not Shown) from the seller 4 at the desired delivery time 81 (See FIG. 21) and notifies the remote server 113 (See FIG. 27), via electronic communications 115 (See FIG. 27), of the pick-up (Not Shown).

Starting at Step 4 of FIG. 24, if there is an accident or delay (Not Shown) and the courier 1 can still delivery the item 7, the courier 1, then starting at Step 5 of FIG. 24, uses electronic communications 115 (See FIG. 27) to notify the buyer 3 of the delay (Not Shown) and provide the buyer 3 with a new estimated time of arrival (Not Shown).

However, if in Step 4 of FIG. 24 there is an accident or delay (Not Shown) and the courier 1 can no longer deliver the item 7, then delivery services 2, starting at Step 6 of FIG. 24, are given to another courier 1 who can deliver the item 7. In Step 6 of FIG. 24, the buyer 3, seller 4, and the new courier 1 are then notified of the change via electronic communications 115 (See FIG. 27). Upon system identification of a disruption in service—for any given courier—that will cause deliveries to not be made or be in danger of not being able to be made in a timely manner, a dispatching algorithm will identify other delivery agents to carry out the affected pick-up/delivery appointments and send notices to those affected, requiring them to consent to the re-appropriation to the algorithm's proposed choices of couriers.

The courier 1, starting at Step 7 of FIG. 24, then delivers the seller's posted item 7 to the buyer 3. In Step 7 of FIG. 24, delivery of the seller's item 7 is confirmed by having the buyer 3 give the courier 1 the buyer's confirmation number 71 (See FIG. 28). The courier 1, in Step 7 of FIG. 24, uses electronic communication 115 (See FIG. 27), to send the confirmation number 71 (See FIG. 28) to the remote server 113 (See FIG. 27). Lastly, starting at Step 8: of FIG. 24, receipt of the confirmation number 71 (See FIG. 28) is saved on the database 25 (See FIG. 27). In Step 8 of FIG. 24, the seller's item posting 10 is then removed from the search index 86 and placed in database archives 87 (See FIG. 27).

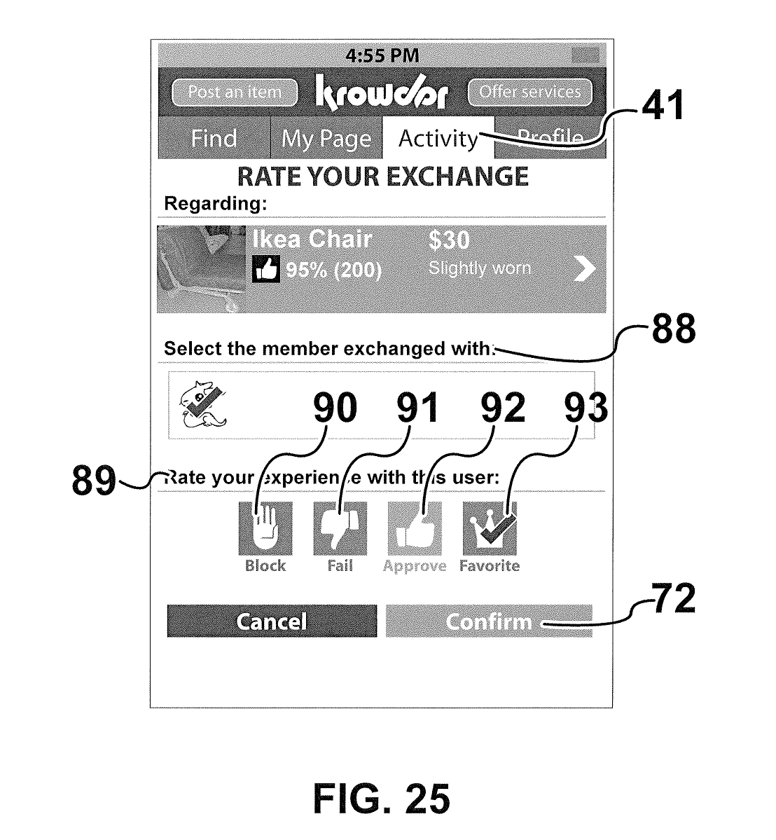

Referring now to FIG. 25, another embodiment of the presently disclosed invention describes the buyer rating process where a buyer 3 can rate his/her experience in the activity page 41 by selecting the seller 4 in the select member field 88. Then, the buyer 3 can select a rating 89 by clicking either: the block button 90, the fail button 91, the approve button 92, or the favorite button 93. The buyer 3 can confirm his/her rating 89 by clicking the confirm button 72.

Referring now to FIG. 26 is an example of how the software script selects creates delivery schedules on a particular day for one courier throughout the day. Part 1 describes the courier's route that was created the day before the delivery. Part 2 describes the courier's route that was created after the courier has left his/her home location to pick-up the first item for the day. Part 3 describes the courier's route that was created when the courier has already picked up his/her first item for the day.

Under Part 1, Seller A 99 has chosen delivery times 81 between 7-11 a.m. Then, Buyer A 100 chooses delivery times 81 between 1-2 p.m. After Buyer A 100 chooses his delivery times 81, the software script 6 (See FIG. 27) calculates a route for the courier with the shortest travel time 102 using a number of factors, including, but not limited to: 1) the distance between the pick-up and drop-off location (Not Shown); 3) the estimated time it will take to travel from the courier's home location to the pick-up location (Not Shown) and 4) the estimated time it will take to travel from the pick-up location to the drop-off location (Not Shown). The courier's route with the shortest travel time 102 is sent electronically to Courier A 101, via an electronic communications 115 (See FIG. 27).

On the delivery day (Not Shown), the courier's route with the shortest travel time 102 has Courier A 101, departing from the courier's home location 103 at 10:40 a.m. and picking up item 1 104 from Seller A 99 at 10:55 a.m. Next, the courier's route with the shortest travel time 102 has Courier A 101: departing from Seller A 99 at 11:00 a.m., dropping off item 1 104 to Buyer A 100 at 1:00 p.m., departing from Buyer A 100 at 1:05 p.m., and finally arriving at Courier A's home location 103 at 1:15 p.m.

Under Part 2, Seller B 105 and Buyer B 106, after Courier A 101 is on route to pick-up item 1 104 from Seller A 99, select delivery times 81 for 9 a.m. though 1 p.m. Since Courier A 101 has already accepted delivery services 2 (Not Shown) for Buyer A 100 and Seller A 99, Courier A 101 cannot deliver item 2 107, until after he/she picks up item 1 104 from Seller A 99.

However, the software script 6 (See FIG. 27) detects that it is feasible for Courier A 101 to deliver item 2 107 from 11 a.m. through 1 p.m. based on the courier's current location 132 and deliverability factors such as the courier's vehicle capacity 133 (See FIG. 4) and the distances between the courier, seller, and buyer's locations (Not Shown). Since it is feasible for the Courier A 101 to deliver, item 2 107, the software script 6 (See FIG. 27) will place Courier A 101 on the list 16 (See FIG. 24).

If Buyer B 106 selects Courier A 101, the software script 6 (See FIG. 27) then calculates a new route 108 based on a number of factors (Discussed Above). In this case, the new route 108 has Courier A 101: picking up item 2 107 from Seller B 105 at 11:20 a.m., departing from Seller B 105 at 11:25 a.m., and dropping off item 2 107 to Buyer B 106 at 11:40 a.m. Courier A 101 will then depart from Buyer B 106 at 11:45 a.m. and continue to drop-off item 1 104 to Buyer A 100 at 1:00 p.m.

Under Part 3, while Courier A's 101 has already picked up item 1 104 from Seller A 99 and is traveling to Seller B 105 to pick up item 2 107, Seller C 109 is selecting delivery times 81 for 11 a.m. through 1:00 p.m. Buyer C 110 is also selecting delivery times 81 for 11 a.m. through 2 p.m. Since Courier A 101 is route to pick-up item 2 107 from Seller B 105, he cannot accept delivery for Seller C's item 3 111 until after he/she picks up item 2 107 from Seller B 105.

However, the software script 6 (See FIG. 27) detects from Courier A's current location 132 that it is feasible for Courier A 101 to deliver item 3 111 from 11 a.m. through 1:00 p.m. Since it is feasible for the Courier A 101 to deliver item 3. 111, the software script 6 (See FIG. 27) will place Courier A 101 on the list 16 (See FIG. 24). If Buyer C 110 selects Courier A 101, the software script 6 (See FIG. 27) then calculates a second new route 112.

In this case, the second new route 112 has Courier A 101: picking up item 3 111 from Seller C 109 at 11:35 a.m., departing from Seller C 109 at 11:40 a.m., dropping off item 3 111 to Buyer C 110 at 11:55 a.m., and departing from Buyer C 110 at 12:00 p.m. However, the software script 6 (See FIG. 27) now has Courier A 101 delivering item 2 107 to Buyer B 106 at 12:10 p.m. and departing from Buyer B 106 at 12:15 p.m. to accommodate delivering item 3 111. Courier A 101 will still deliver item 1 104 to Buyer A 100 at 1:00 p.m.

The software script 6 (See FIG. 27) knows where Courier A 101 is located at select times during the day because couriers 1 send electronic communications 115 to the remote server 113 when the courier 1 has picked up and dropped off an item 7 (See FIG. 27). Through these electronic communications 115 (See FIG. 27), the software script 6 (See FIG. 27) knows the current courier's location 132 (See FIG. 26) and can therefore determine if it is feasible for the courier 1 to deliver another seller's item 7.

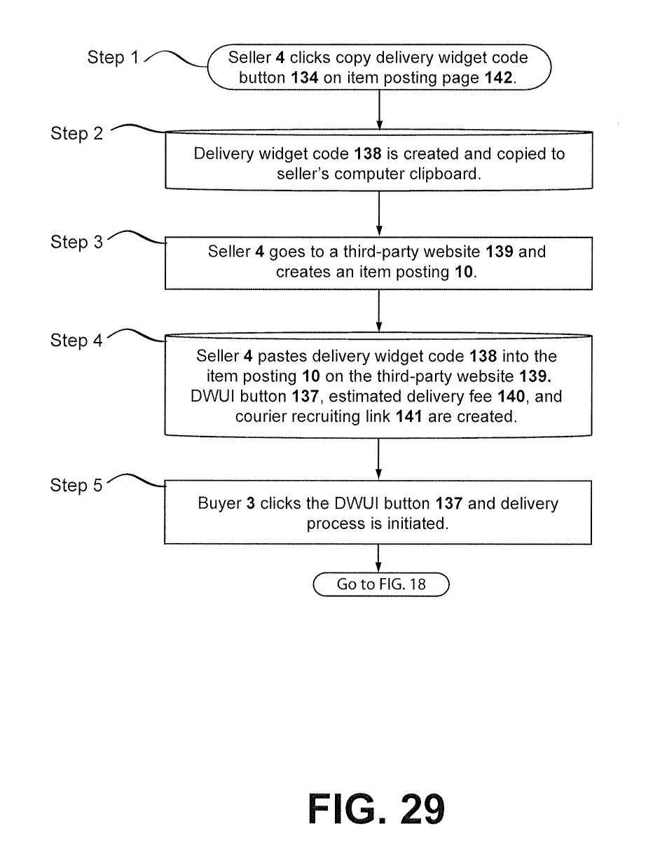

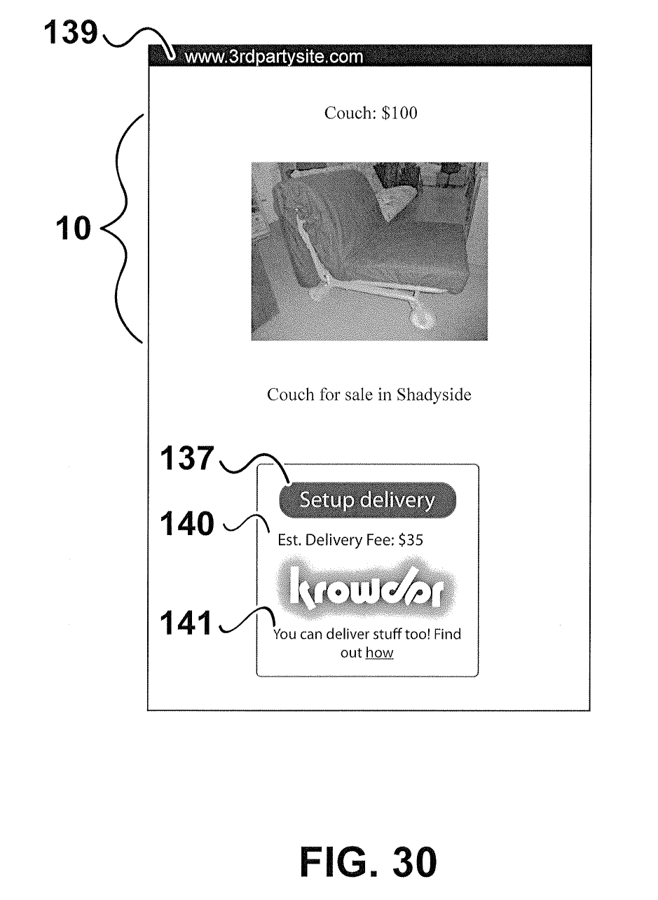

Referring now to FIG. 29, one embodiment of the presently disclosed invention further shows the process flow having a seller use a web widget to post item information and allow a buyer to initiate delivery of the seller's item on a third party website. FIGS. 10 and 30 show the accompanying schematics to the process flows as described in FIG. 29. More specifically, FIG. 10 is a schematic showing the delivery widget code button and FIG. 30 is a schematic of the seller's item posting on the third party website.

Referring now to FIG. 29, the seller 4, starting at Step 1, clicks the copy delivery widget code button 134 on the item-posting page 142 (See FIG. 10). Starting at Step 2 of FIG. 29, a delivery widget code (Not Shown) is then created and copied to a seller's computer clipboard (Not Shown). Next, starting at Step 3 of FIG. 29, the seller 4 goes to a third-party website 139 and creates an item posting 10 (See FIG. 30). Next, starting at Step 4 of FIG. 29, the seller 4 pastes the delivery widget code (Not Shown) from his/her computer's clipboard (Not Shown) onto the third-party website 139, thereby creating a delivery widget user interface button (DWUI button) 137 onto the item posting 10 that is located on the third-party website (See FIG. 30). In Step 4 of FIG. 29, an estimated delivery fee 140, which is estimated by the imputed dimensions and other descriptive features as seen in FIG. 9, and a courier recruiting link 141 is also added to the third party website. (See FIG. 30). Finally, starting at Step 5 of FIG. 29, a buyer 3 clicks the delivery DWUI button 137 on the third party website 139, thereby leading the buyer 3 to the delivery scheduling process outlined in FIG. 18.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. An Internet-based computer system for fostering connections between an offeror, an offeree, and a third party intermediary over a remote server having a software script comprising the steps of:
compiling a relevant scheduling information from the offeror, the offeree, and the third party intermediary,
analyzing the complied relevant scheduling information from the offeror, the offeree, and the third party intermediary,
considering a time and a physical location-based factors in the scheduling information analysis,
creating an event coordination schedule from the scheduling information analysis,
displaying the optimized event coordination schedule in a readable form for the offeror, the offeree, and the third party intermediary,
allowing a one or more of the three or more parties to select a desired scheduled time, and
assisting a coordination of a physical activity between each of the offeror, the offeree, and the third party intermediary using the software script.

2. A method of facilitating virtual connections between three or more parties electronically comprising:
connecting an offeror, an offeree, and a third party intermediary to a remote server;
facilitating a virtual communication between the offeror, the offeree, and the third party intermediary;
compiling a time and location-based information concerning each of the offeror, the offeree, and the third party intermediary;
analyzing the time and location-based information concerning each of the offeror, the offeree, and the third party intermediary with an external factor;
calculating a conclusion from the analysis;
sending a readable form of the conclusion to each of the offeror, the offeree, and the third party intermediary on the remote server; and
facilitating an interaction between the offeror, the offeree, and the third party intermediary resulting from the conclusion.

3. The method as defined in claim 2 wherein the steps of calculating a conclusion from the analysis further comprises times and places that the offeror, the offeree, and the third party intermediary would coordinate in a synchronous manner.

4. The method as defined in claim 2 wherein the steps of calculating a conclusion from the analysis further comprises times and places that the offeror, the offeree, and the third party intermediary would coordinate in an asynchronous manner.

5. A method of connecting a buyer, a seller, and a courier to facilitate a transfer and delivery of physical goods over a remote server, the method comprising the steps of:
logging onto a remote server by a buyer, a seller, and a courier;
creating a user profile of the buyer, the seller, and the courier on the remote server;
uploading a schedule of available delivery times for the buyer, the seller, and the courier to the remote server;
posting information on a seller's posted item by the seller to the remote server;
displaying a price for the seller's posted item by the seller on the remote server;
conducting a search for the seller's posted item by the buyer on the remote server;
confirming a purchase of the seller's posted item by the buyer on the remote server;
calculating, using a software script, a deliverability of the seller's posted item;
uploading a seller's schedule of available pick-up times for the seller's posted item to the remote server;
comparing the seller's schedules of available delivery times to a courier's schedule of available delivery times for the seller's posted item;
comparing a size of the seller's item to a couriers' vehicle size to determine if the item can be delivered by the courier;
comparing a couriers' previously scheduled deliveries to determine if the item can be delivery by the couriers;
creating, using a software script, a combined schedule of available delivery times, from an available couriers' schedules of available delivery times and the seller's schedule of available pick-up times;
displaying the combined schedule of available delivery times to the buyer;
choosing a desired delivery time and a chosen courier from the combined schedule of available delivery times by the buyer;
calculating a delivery price based on prices given by the chosen courier using the software script;
calculating, using the software script, a total price for the buyer by adding the delivery price to the seller's posted item price;
confirming an electronic payment by the buyer on the remote server;
sending the buyer's electronic payment and shipping payment to an electronic escrow holding accounts for the chosen courier and the seller;
saving a confirmation of both the buyer and the seller to a database of the remote server;
notifying the chosen courier of the information of a delivery of the desired seller's posted item;
notifying the buyer and seller of the delivery time and the chosen courier;
picking up the seller's posted item by the courier at a seller's desired pick-up location;
dropping off the seller's posted item by the courier at a buyer's desired drop-off location;
signing a delivery conformation by the buyer when the seller's posted item is dropped off at the buyer's desired drop-off location;
sending the delivery conformation electronically to the remote server;
recognizing the delivery conformation by the software script;
recognizing a location of the courier at a time the delivery conformation was sent;
transferring the electronic payment from the electronic escrow holding accounts to a money accounts of the seller and the courier; and
calculating whether the chosen courier can delivery another item from a different seller to a different buyer by the software script.

6. The method as defined in claim 5 wherein the steps of creating the combined schedule of available delivery times further comprises comparing the seller's schedule of available pick-up times and the couriers' schedules of available delivery times to a distance between the location of the courier at the time the calculation is made and the seller's pick-up location.

7. The method as defined in claim 6 wherein the steps of determining the location of the courier further comprises of looking up, using the software script, a courier's location at the time the buyer's confirmation was sent to the remote server.

8. The method as defined in claim 5 wherein the steps of creating the combined schedule of available delivery times further comprises comparing the seller's schedule of available pick-up times and the couriers' schedules of available delivery times to a distance between the seller's pick-up location and the buyer's drop-off location.

9. The method as defined in claim 5 wherein the steps of creating the combined schedule of available delivery times further comprises comparing the seller's schedule of available pick-up times and the couriers' schedules of available delivery times to an estimated time it will take to travel from the courier's location at the time the calculation is made to the seller's pick-up location.

10. The method as defined in claim 5 wherein the steps of creating the combined schedule of available delivery times further comprises comparing the seller's schedule of available pick-up times and the couriers' schedules of available delivery times to an estimated time it will take to travel from the seller's pick-up location to the buyer's drop-off location.

11. The method as defined in claim 5 wherein the steps of determining whether a courier is available to deliver an item based on the courier's previously scheduled deliveries further comprises:
requiring the courier to send electronic notification to the software script via the remote server after each pick-up and drop-off activity is completed;
checking, using the software script, where the courier is currently located based on the courier's last electronic notification;
calculating an estimated time it will take to travel from the courier's current location to a next pick-up location;
calculating the estimated time it will take to travel from the pick-up location to a drop-off location.

12. The method as defined in claim 5, wherein the seller's posted information may be viewed by the buyer on a third-party website using a web widget.

13. The method as defined in claim 12, wherein the web widget allows the buyer to initiate a delivery process from within a post on the third-party website.
